(19) United States
(12) Patent Application Publication
(10) Pub. No.: US 2010/0321417 A1
(43) Pub. Date: Dec. 23, 2010

(54) DISPLAY DEVICE AND PROJECTION DISPLAY DEVICE

(75) Inventors: Hidehito Iisaka, Shiojiri-shi (JP); Shohei Yoshida, Shimosuwa-cho (JP); Takashi Takeda, Suwa-shi (JP); Hidefumi Sakata, Tatsuno-cho (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/855,826

(22) Filed: Aug. 13, 2010

Related U.S. Application Data
(63) Continuation of application No. 10/851,218, filed on May 24, 2004.

(30) Foreign Application Priority Data
May 29, 2003 (JP) 2003-152623

(51) Int. Cl. G09G 5/10

(52) U.S. Cl. 345/690

(57) ABSTRACT

The invention provides a display device, a direct-view display device, and a projection display device in which their apparent dynamic ranges are increased with less color change. The display device can include a light modulation device having a plurality of pixels for displaying an image according to an image signal, a light source for illuminating the light modulation device, and a light-source driving device for controlling the intensity of light emitted from the light source by controlling the period in which the light source is lit at a specified brightness per unit time.

This is a Continuation of application Ser. No. 10/851,218 filed May 24, 2004. The disclosure of the prior application is hereby incorporated by reference herein in its entirety.

### BACKGROUND OF THE INVENTION

1. Field of Invention

The present invention relates to an image display device, a direct-view display device, and a projection display device. More particularly, the invention relates to an image display technique capable of controlling the brightness.

2. Description of Related Art

It has recently been considered to control the brightness of the light sources of direct-view and projection display devices depending on the contents of displays in order to increase the apparent dynamic range (gray scale) of a display.

Known display devices, capable of controlling the brightness of the light source depending on the display contents, include one capable of controlling the light source itself. See, for example, JP-A-03-179886 (pp. 3 to 4, FIG. 1).

### SUMMARY OF THE INVENTION

The above-described method has the problem that the color of the display images has changed because emission spectrum is varied by controlling the brightness of a light source.

It is an object of the invention to provide a display device, a direct-view display device, and a projection display device in which their apparent dynamic ranges are increased without influence on the color.

A display device according to the invention can include a light modulation device having a plurality of pixels for displaying an image according to an image signal. The display device includes a light source for illuminating the light modulation device, and light-source driving means for controlling the intensity of light by controlling the period in which the light source is lit at a specified brightness per unit time.

More specifically, in the display device of the invention, the light emitted from the light source irradiates the display device to form an image based on an image signal. When the display device displays a dark image, the light-source driving device controls the period in which the light source is lit at a specified brightness on the basis of the image signal to thereby control the intensity of light emitted from the light source per unit time.

Accordingly when a dark image signal is inputted, the period in which the light source is lit at a specified brightness is reduced, decreasing the intensity of light emitted from the light source per unit time, and thus darkening the display image. On the other hand, when a bright image signal is inputted, the period in which the light source is lit at a specified brightness is increased, increasing the intensity of light emitted from the light source per unit time, and thus lightening the display image. Therefore, a displayable gray scale is increased to allow the apparent dynamic range to be increased.

Since the intensity of the light source during the lighting period is constant, the emission spectrum does not vary and so the color of the display image does not vary. Furthermore, since the lighting period of the light source is controlled within the time width in one unit time, the display is of impulse display system, thus increasing moving-picture viewability.

In the display device of the invention, preferably, the light-source driving device can have a brightness extraction device for extracting a parameter characterizing the brightness of image from the image signal, and the light-source driving device controls the intensity of light emitted from the light source on the basis of the parameter extracted by the brightness extraction device.

Since the intensity of the light emitted from the light source is controlled depending on the parameter that characterizes the brightness of the image, the light intensity is controlled to display an image with appropriate brightness. Accordingly, the allowable intensity control range of the light source can be used effectively, and so the dynamic range of the display image can be further increased.

Preferably, the display device of the invention is controlled so that the image signal displayed by the light modulation device is subjected to image processing on the basis of the parameter characterizing the brightness of the image. In addition to the light-source intensity control, such image-signal processing is performed. Thus, not only the brightness of the image but also the contrast of the display image can be increased, and so the image reproducibility can be further improved.

In the display device of the invention, preferably, the light-source driving device controls the number of lightings of the light source to one per unit time and controls the lighting period for each one time to thereby control the intensity of light emitted from the light source per unit time.

In the display device of the invention, the light-source driving device controls the number of lightings of the light source to one per unit time and controls also the lighting period. In other words, the intensity of the light emitted from the light source per unit time can be controlled depending on the length of the light-source lighting period.

In the display device of the invention, preferably, the light-source driving device controls the number of lightings of the light source to a specified number of two or more per unit time and controls the lighting period for each one time to thereby control the intensity of light emitted from the light source per unit time. Since the number of lightings per unit time is a specific number of two or more, the lighting frequency of the light source is higher than the image frequency. An increase in the light-source lighting frequency makes it difficult for human eyes to perceive the blinking of the light source, thus reducing the flickering (image flickering).

In the display device of the invention, preferably, the light-source driving means fixes the lighting period of the light source to a specified lighting period and controls the number of lightings per unit time to thereby control the intensity of light emitted from the light source per unit time. More preferably, the specified lighting period is the time from the light source is turned on until the brightness becomes equal to that at steady-state lighting (hereinafter, referred to as a minimum lighting period).

Since the intensity of light emitted from the light source is controlled by fixing the lighting period at one time to the minimum lighting period and controlling the number of lightings per unit time, the light-source lighting frequency is substantially higher than the image frequency. An increase in the light-source lighting frequency makes it difficult for human eyes to perceive the blinking of the light source, thus reducing the flickering caused by the blinking of the light source.

In the display device of the invention, preferably, the light-source driving means controls the light source to be lit all the time when the parameter characterizing the brightness of the image is at the maximum. Since the light source is lit all the time when the brightness of the image signal is at the maximum, or the brightness of the image is at the maximum, the flickering of the brightness of the image is completely eliminated. The elimination of the image flickering eliminates the burden on eyes, thus reducing eyestrain.

In the display device of the invention, preferably, the light-source driving means controls the light source to be lit intermittently when the parameter characterizing the brightness of the image 1 is at the maximum. Since the light source is lit intermittently even when the brightness of the image signal is at the maximum, the display is of impulse display system not only during light-control but also when the brightness of the image is at the maximum; thus, moving-picture viewability is improved.

In the display device of the invention, preferably, the light-source driving means controls the lighting period in which the light source is lit at a specified brightness per unit time and controls the light source to be turned on at a brightness lower than the specified brightness during the time other than the lighting period. More preferably, the above-mentioned lower brightness is the one at the period in which the light source is lit all the time when the brightness of the image signal is the lowest. Since the light source is turned on at a brightness at the period in which the light source is lit all the time when the brightness of the image signal is the lowest (hereinafter, referred to as the minimum brightness) even during the time other than the lighting time, the difference in the brightness of the light source per unit time is reduced. The decrease of the difference in brightness reduces flickering, thus reducing eyestrain. Particularly, flickering in dark images is reduced.

The display device of the invention can be applied to a display device including a light modulator and a display device of a projection display device that projects light modulated by a light modulator.

The use of the display device in the projection display device increases the apparent dynamic range and reduces power consumption.

Preferably, the projection display device includes three light modulation elements corresponding to the three primary colors, and three light sources capable of emitting the respective color lights, and the light-source driving device shifts the lighting timing of the light-source for each of the different color lights. The shift of lighting timing of the light-source for different color lights allows the peaks of power consumption by the lighting of the light source to be dispersed, reducing the peak power consumption of the projection display device as a whole, and further reducing the power consumption.

Preferably, the projection display device includes three light modulation elements corresponding to the three primary colors, and three light sources capable of emitting the respective color lights; and the light-source driving device coincides all the lighting timing of the light-source with one another. The conformation of all the lighting timing of the light-source allows the different color lights to be emitted at the same time, thus preventing a color breakup phenomenon, in which the color lights appear to be separated in time on the image.

The projection display device of the invention may use light-emitting diodes (hereinafter, referred to as LEDs) as light source capable of emitting different color lights. High-output LEDs are provided at present for the color lights of R, G, and B. This type of LEDs can be arranged in planar shape or curved shape in array. The LEDs can be turned on and off relatively easily at a high frequency, thus providing a preferable light source for the projection display device of the invention.

The display device of the invention may be applied to a direct-view display device including a light source and a display device that modulates the light from the light source. Providing the display device to the direct-view display device increases the apparent dynamic range and reduces power consumption.

### BRIEF DESCRIPTION OF THE DRAWINGS

The invention will be described with reference to the accompanying drawings, wherein like numerals reference like elements, and wherein:

FIG. 1 is a schematic diagram of a projection display device according to a first embodiment of the present invention;

FIG. 2 is a time chart of the flash timings of LEDs of a first example;

FIG. 3 is a graph plotting the brightness necessary for images against the percentage of the lighting period in this example;

FIG. 4 is a time chart of the flash timings of LEDs of a second example;

FIG. 5 is a time chart of the flash timings of LEDs of a third example;

FIG. 6 is a time chart of the flash timings of LEDs of a fourth example;

FIG. 7 is a time chart of the flash timings of LEDs of a fifth example;

FIG. 8 is a schematic diagram of a direct-view display device according to a second embodiment of the invention;

FIG. 9 is a time chart of the flash timing of an LED of the second embodiment; and

FIG. 10 is a graph plotting the brightness necessary for images against the percentage of the lighting period in the second embodiment.

### DETAILED DESCRIPTION OF PREFERRED EMBODIMENTS

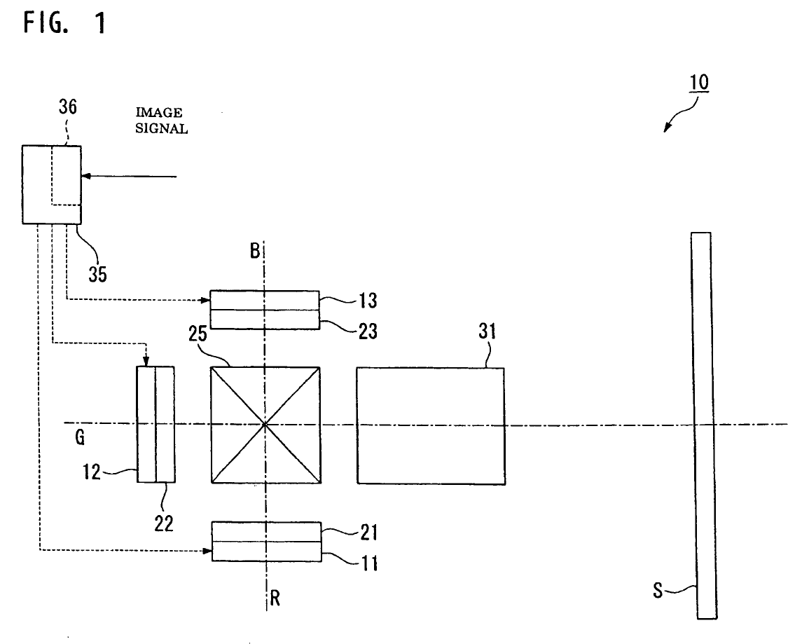

Referring to FIGS. 1 to 3, a first example of a first embodiment will now be described.

The embodiment describes a three-plate projection liquid-crystal display device by way of example. FIG. 1 is a schematic diagram of the overall structure of a projection display device 10. Numerals 11, 12, and 13 denote LEDs (light sources); numerals 21, 22, and 23 denote liquid-crystal light valves (display devices); numeral 25 denotes a cross-dichroic prism; numeral 31 denotes a projector lens (projection device); and numeral 35 denotes a light-source controller (light-source driving device).

Referring to FIG. 1, the projection display device 10 of the embodiment can include the LEDs 11, 12, and 13 capable of emitting R-, G-, and B-color lights, respectively, the liquid-crystal light valves 21, 22, and 23 corresponding to the R, G, and B for modulating the color lights emitted from the LEDs 11, 12, and 13, respectively, the cross-dichroic prism 25 that combines the modulated color lights, the projector lens 31 for projecting the combined light flux to a screen S, and the light-source controller 35 for controlling the blinking of the LEDs 11, 12, and 13. It is also possible to provide for uniformizing the illumination and for arranging the direction of polarization in one direction between the LED light sources and the liquid-crystal light valves, which are not described in this embodiment.

The LEDs 11, 12, and 13 are arranged to face the respective surfaces of the cross-dichroic prism 25 and so as to emit the respective color lights toward the cross-dichroic prism 25. The liquid-crystal light valves 21, 22, and 23 are arranged between the LEDs 11, 12, and 13 and the cross-dichroic prism 25, respectively.

Each of the liquid-crystal light valves 21, 22, and 23 can include a liquid-crystal panel, an incident-end polarizing plate (not shown), and an emerging-end polarizing plate (not shown). The liquid-crystal panel uses an active-matrix transmissive liquid-crystal cell in twisted nematic (TN) mode that uses a thin film transistor (hereinafter, referred to as a TFT) as pixel-switching element.

The cross-dichroic prism 25 is constructed such that four rectangular prisms are bonded together, of which the inner surface has a dielectric multilayer film that reflects red light and a dielectric multilayer film that reflects blue light in cross shape.

The light-source controller 35 can include a brightness extraction section (brightness extraction device) for extracting the maximum brightness of an image from the inputted image signal and outputting maximum-brightness data to the light-source controller 35.

The operation of the projection display device 10 with the above-described structure will now be described.

Referring to FIG. 1, the color lights R, G, and B emitted from the LEDs 11, 12, and 13, respectively, are incident to the liquid-crystal light valves 21, 22, and 23 corresponding to the respective color lights, respectively. The incident color lights are modulated by the liquid-crystal light valves 21, 22, and 23 in accordance with the image signal and are then incident to the cross-dichroic prism 25. The modulated color lights are combined by the cross-dichroic prism 25 and are then incident to the projector lens 31. The projector lens 31 projects the combined color lights toward the screen S in magnification.

The lighting control of the LEDs 11, 12, and 13, which is the feature of the invention, will now be described.

Referring to FIG. 1, the image signal is inputted to the brightness extracting section 36, wherein the maximum brightness of the image in one field, is calculated. The calculated maximum brightness is outputted to the light-source controller 35.

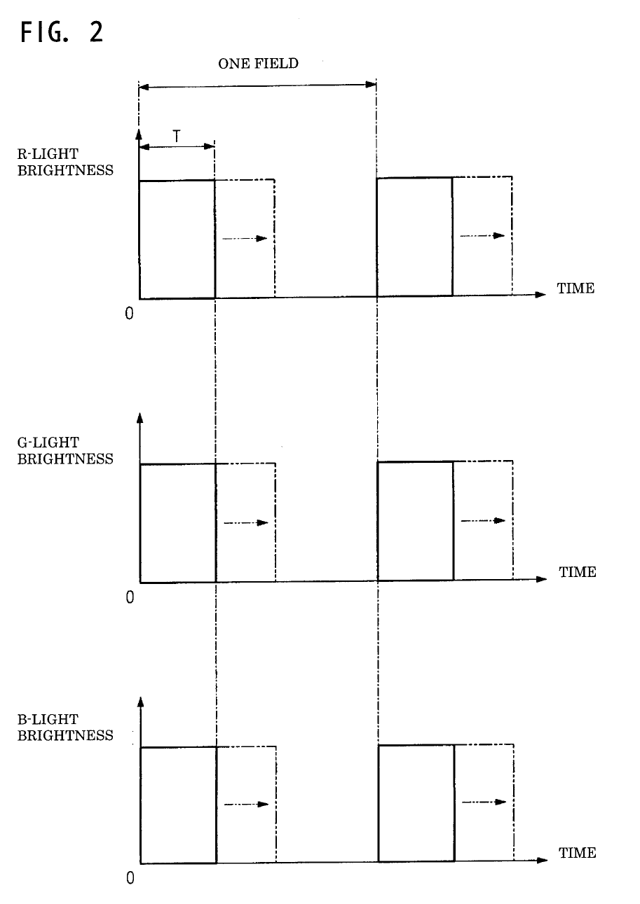

FIG. 2 is a time chart of the flash timings of the LEDs 11, 12, and 13 of this example.

The light-source controller 35 first determines a light intensity necessary for one field from the inputted maximum brightness. The light-source controller 35 then determines a lighting period T necessary for emitting the light intensity when the LEDs 11, 12, and 13 emit light at a brightness M at the time when a rated current is fed.

Referring to FIG. 2, when the lighting period T has been determined, the light-source controller 35 turns on the LEDs 11, 12, and 13 one time per one field for the lighting period T at the same time. For example, when the maximum brightness calculated from the image signal is increased, the light intensity required for one field is increased. Since the brightness of the LEDs 11, 12, and 13 reaches the upper limit at the time when the rated current is fed, as described above, the lighting period is increased in order to increase the light intensity for one field. Briefly, as indicated by the chain double-dashed line in FIG. 2, the lighting period of the LEDs 11, 12, and 13 in one field is increased.

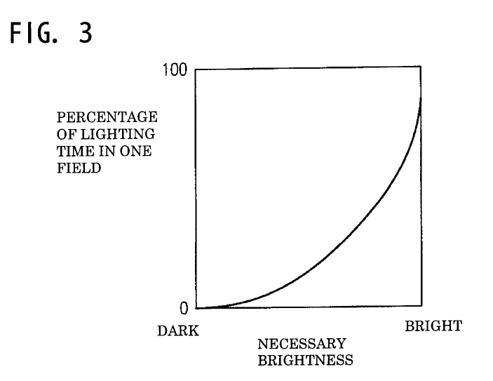

FIG. 3 is a graph plotting the necessary brightness calculated from the maximum brightness against the percentage of the lighting period for one field.

The lighting period of the LEDs 11, 12, and 13 in one field is set so as to be increased when the brightness calculated from the maximum brightness becomes stronger (an increase of light intensity), as shown in FIG. 3. The percentage of the lighting period in one field does not become 100 percent even in maximum-brightness display; the LEDs 11, 12, and 13 are being lit intermittently.

With such a structure, the light intensity applied to the liquid-crystal light valves 21, 22, and 23 in one field can be measured depending on the maximum brightness of the image signal, and the lighting period in which the LEDs 11, 12, and 13 are lit in one field can be measured from the light intensity.

In other words, the lower the maximum brightness of the image signal is, the shorter the period in which the LEDs 11, 12, and 13 are lit in one field is, and so the display image is darkened; on the other hand, the higher the maximum brightness of the image signal is, the longer the period in which the LEDs 11, 12, and 13 are lit in one field is, and so the display image is lightened. Accordingly, the displayable gray scale is increased, so that the apparent dynamic range can be expanded.

More specifically, the LEDs 11, 12, and 13 are turned on one time simultaneously in one field. In other words, the LEDs 11, 12, and 13 are turned on and off simultaneously, thus preventing the color of the display image from being viewed separately in time. Since the lighting time of the LEDs 11, 12, and 13 is controlled within the time width less than one field, the images are switched by impulse display system, thus improving moving-image viewability.

The lighting period of the LEDs 11, 12, and 13 is set so that only necessary light intensity can be emitted depending on the maximum brightness of the image signal. In this case, the light intensity of the light source is constant during the lighting period; therefore, the emission spectrum does not vary, thus preventing the color of the image from varying.

Each of the LEDs 11, 12, and 13 is controlled to emit light intermittently even when maximum brightness of the image signal is at the maximum, therefore ensuring moving-image viewability even when the brightness of the image is at the maximum.

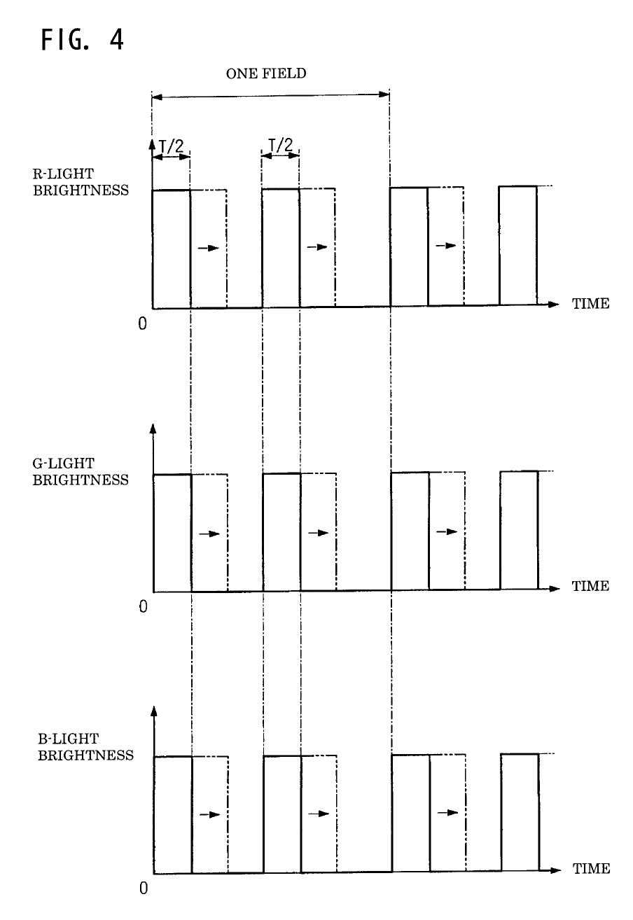

Referring now to FIG. 4, a second example of the invention will be described. Although the principal structure of the projection display device of the example is the same as that of the first example, the flash patterns of the LEDs 11, 12, and 13 are different therefrom. Accordingly, in this example, only the description of the flash control of the LEDs 11, 12, and 13 will be provided with reference to FIG. 4 and the description of the light sources and so on will be omitted.

The operation of the projection display device 10 with such a structure will be described.

FIG. 4 is a time chart of the flash timings of the LEDs 11, 12, and 13 of this example.

As set forth hereinabove, the light-source controller 35 first determines a light intensity necessary for one field from the inputted maximum brightness. The light-source controller 35 then determines a lighting period T necessary for emitting the light intensity. When the lighting period T has been determined, the light-source controller 35 divides the lighting period into two and turns on the LEDs 11, 12, and 13 two times per one field for the lighting period of T/2 at the same time, as shown in FIG. 4.

When the maximum brightness calculated from the image signal is increased, the light-source controller 35 increases the lighting period to increase the intensity of the light emitted from the LEDs 11, 12, and 13 in one field. Briefly, as indicated by the chain double-dashed line in FIG. 4, the lighting period of the LEDs 11, 12, and 13 in each lighting period is increased.

With the above structure, since the number of lightings of the LEDs 11, 12, and 13 for one field is set at two, the lighting frequencies of the LEDs 11, 12, and 13 are approximately twice as high as the image frequency. The increase in lighting frequency of the LEDs 11, 12, and 13 makes it difficult for human eyes to perceive the blinking of the LEDs 11, 12, and 13, thus reducing flickering (image flickering).

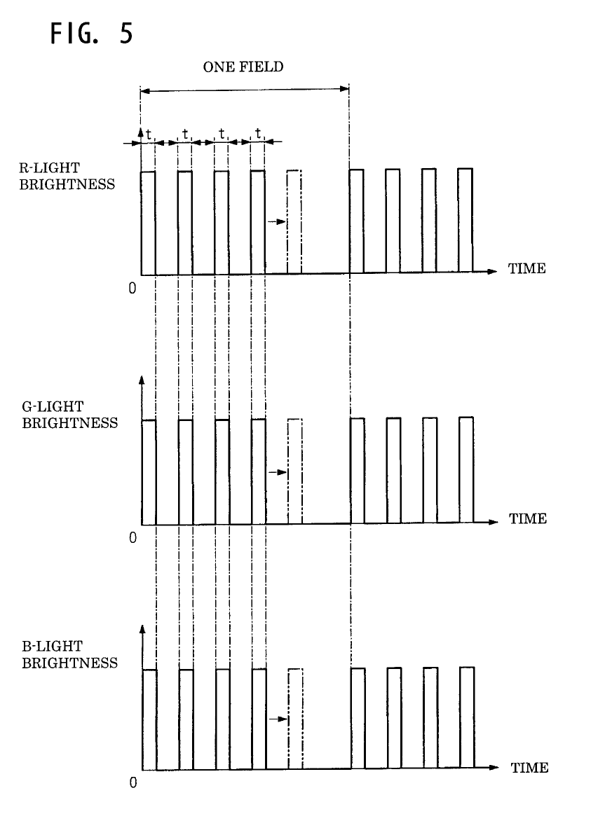

Referring now to FIG. 5, a third example of the invention will be described. Although the principal structure of the projection display device of the example is the same as that of the first example, the flash patterns of the LEDs 11, 12, and 13 are different therefrom. Accordingly, in this example, only the description of the flash control of the LEDs 11, 12, and 13 will be provided with reference to FIG. 5 and the description of the light sources and so on will be omitted.

The operation of the projection display device 10 with such a structure will be described.

FIG. 5 is a time chart of the flash timings of the LEDs 11, 12, and 13 of this example.

As set forth hereinabove, the light-source controller 35 first determines a light intensity necessary for one field from the inputted maximum brightness. The light-source controller 35 then determines a lighting period T necessary for emitting the light intensity. When the lighting period T has been determined, the light-source controller 35 divides the light period T by the later-described minimum lighting period t (into four in FIG. 5), as shown in FIG. 5. The LEDs 11, 12, and 13 are turned on at the number of times that is obtained by dividing the lighting period T in one field by the minimum lighting period t, for the minimum lighting period t for each lighting at the same time. The minimum lighting period t in this case means the time from the LEDs 11, 12, and 13 are turned on until the brightness becomes equal to that at steady-state lighting.

When the brightness calculated from the image signal is increased, the light-source controller 35 increases the number of lightings to increase the intensity of the light emitted from the LEDs 11, 12, and 13 in one field. Briefly, as indicated by the chain double-dashed line in FIG. 5, the number of lightings of the LEDs 11, 12, and 13 in one field is increased.

With the above structure, the light-source controller 35 controls the intensity of light emitted from the light source by fixing the lighting period of the LEDs 11, 12, and 13 at one time to the minimum lighting period t and controlling the number of lightings in one field. Accordingly, the lighting frequencies of the LEDs 11, 12, and 13 are substantially higher than the image frequency, making it difficult for human eyes to perceive the blinking of the LEDs 11, 12, and 13, thus reducing the flickering due to the blinking of the LEDs 11, 12, and 13.

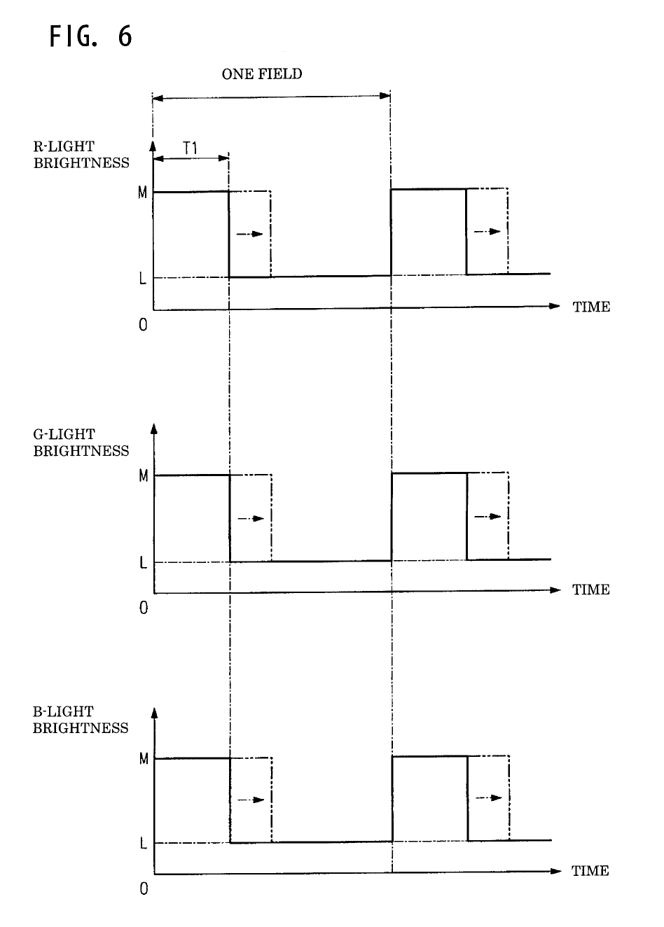

Referring now to FIG. 6, a fourth example of the invention will be described.

Although the principal structure of the projection display device of the example is the same as that of the first example, the flash patterns of the LEDs 11, 12, and 13 are different therefrom. Accordingly, in this example, only the description of the flash control of the LEDs 11, 12, and 13 will be provided with reference to FIG. 6 and the description of the light sources and so on will be omitted.

The operation of the projection display device 10 with such a structure will be described. FIG. 6 is a time chart of the flash timings of the LEDs 11, 12, and 13 of this example.

As set forth hereinabove, the light-source controller 35 first determines a light intensity necessary for one field from the inputted maximum brightness. At this time, a minimum brightness L is set for the light-intensity control range. The brightness L is obtained by steady-state lighting of the light source. The light-source controller 35 determines a lighting period T1 necessary for emitting light having necessary light intensity in consideration of that.

When the lighting period T1 has been determined, the light-source controller 35 turns on the LEDs 11, 12, and 13 at the brightness L all the time and at the brightness M only one time in one field at the time when a rated current is fed, as shown in FIG. 6. The lighting period at the brightness M is the above-described T1. The LEDs 11, 12, and 13 are turned on at the brightness M at the same time.

When the maximum brightness calculated from the image signal is increased, the light-source controller 35 increases the period in which the LEDs 11, 12, and 13 are lit at the brightness M to increase the intensity of light emitted from the LEDs 11, 12, and 13 in one field. Briefly, as indicated by the chain double-dashed line in FIG. 4, the lighting period of the LEDs 11, 12, and 13 at the brightness M during lighting is increased.

With such a structure, the LEDs 11, 12, and 13 are lit at the brightness L even at the period in which the LEDs 11, 12, and 13 are lit out in other examples. Accordingly, the ratio of the brightest display and the darkest display in one field, or the difference in brightness, is decreased. The decrease in the difference in brightness reduces flicker, thus reducing eyestrain and, particularly, flickering in dark images.

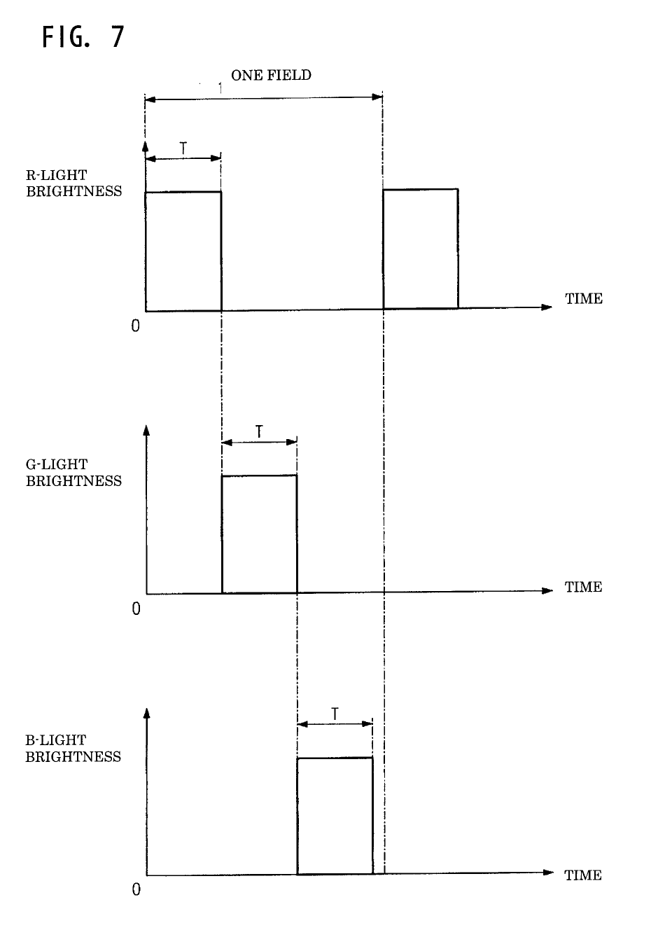

Referring now to FIG. 7, a fifth example of the invention will be described.

Although the principal structure of the projection display device of the example is the same as that of the first example, the flash patterns of the LEDs 11, 12, and 13 are different therefrom. Accordingly, in this example, only the description of the flash control of the LEDs 11, 12, and 13 will be provided with reference to FIG. 7 and the description of the light sources and so on will be omitted.

As set forth hereinabove, the light-source controller 35 first determines a light intensity necessary for one field from the inputted maximum brightness and then determines the lighting period T necessary for emitting the light intensity. When the lighting period T has been determined, the light-source controller 35 turns on the LEDs 11, 12, and 13 one time for one field for the lighting period T, with the timings shifted in the order of the LEDs 11, 12, and 13 so that they are not turned on at the same time, as shown in FIG. 7.

With the above structure, by shifting the lighting timings of the LEDs 11, 12, and 13 for each of the different color lights, the peaks of power consumption by the lighting of the LEDs 11, 12, and 13 can be dispersed, and the entire peak power consumption of the projection display device 10 can be reduced. Therefore the power consumption can be further reduced.

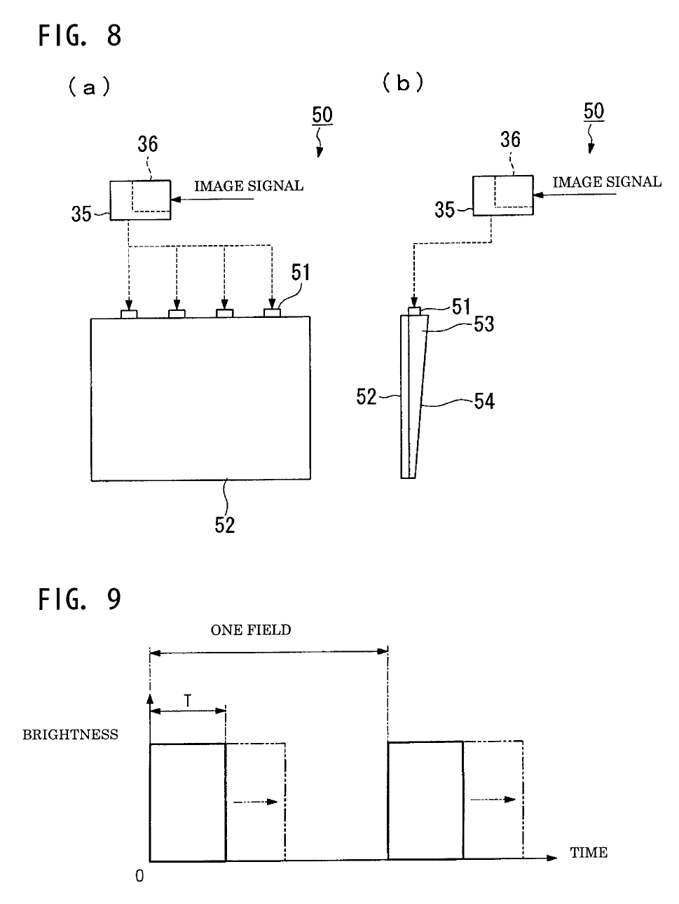

Referring now to FIGS. 8 to 10, a second embodiment of the invention will be described. This embodiment will be described using a direct-view liquid crystal display device as an example. The same components as those of the first embodiment are given the same numerals and their description will be omitted here. FIG. 8(a) is a schematic front view of the overall structure of a direct-view display device 50; and FIG. 8(b) is a schematic side view of the direct-view display device 50.

As shown in FIG. 8, the direct-view display device 50 of the embodiment includes an LED (light source) 51 capable of emitting white light, a liquid-crystal cell (display device) 52 that modulates the white light emitted from the LED 51, a light guide 53 that guides the white light emitted from the LED 51 to the liquid-crystal cell 52, and the light-source controller 35 that controls the LED 51.

The LED 51 is arranged on the upper end of the light guide 53 so as to emit white light toward the light guide 53.

The light guide 53 has approximately the same size as that of the liquid-crystal cell 52, viewed from the front, such that a rear surface 54 is inclined forwardly from the upper part to the lower part, viewed from the side.

The liquid-crystal cell 52 includes an incident-end polarizing plate (not shown) and an emerging-end polarizing plate (not shown). The liquid-crystal cell 52 uses an active-matrix transmissive liquid-crystal cell in twisted nematic (TN) mode that uses a thin film transistor (TFT) as pixel-switching element.

The operation of the direct-view display device 50 with such a structure will be described. Referring to FIG. 8, the white light emitted from the LED 51 is incident to the light guide 53 through the upper end of the light guide 53. The white light incident to the light guide 53 propagates in the light guide 53 while being reflected therein, and part of which is reflected by the rear surface 54 having an inclination angle to propagate toward the liquid-crystal cell 52. The white light incident to the liquid-crystal cell 52 is modulated by the liquid-crystal cell 52 in accordance with the image signal to form an image.

As shown in FIG. 8, the image signal is inputted to the brightness extracting section 36, wherein the maximum tone of the image signal in one field, or the maximum brightness of the image in one field, is calculated. The calculated maximum brightness is outputted to the light-source controller 35.

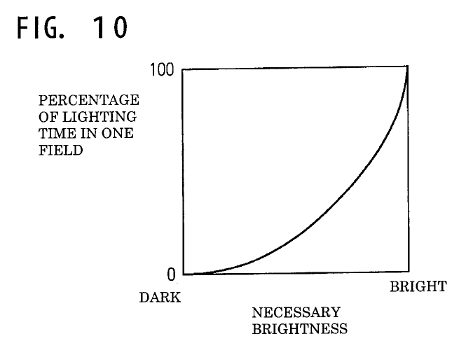

FIG. 9 is a time chart of the flash timing of the LED 51 of this embodiment. The light-source controller 35 first determines a light intensity necessary for one field from the inputted maximum brightness. The light-source controller 35 then determines a lighting period T necessary for emitting the light intensity when the LED 51 emits light at a brightness M at the time when a rated current is fed.

Referring to FIG. 9, when the lighting period T has been determined, the light-source controller 35 turns on the LED 51 one time per one field for the lighting period T.

FIG. 10 is a graph plotting the necessary brightness calculated from a maximum brightness against the percentage of the lighting period for one field. The lighting period of the LED 51 in one field is set so as to be increased when the brightness calculated from the maximum brightness (with increasing light intensity) becomes stronger, as shown in FIG. 10. The percentage of the lighting period in one field becomes 100 percent in maximum-brightness display, and the LED 51 is being lit all the time.

With the above structure, the LED 51 is lit all the time when the maximum brightness of the image signal is at the maximum, or the brightness of the image is at the maximum, thus eliminating image flickering. The elimination of the image flickering decreases the burden on eyes, thus reducing eyestrain.

It is to be understood that the technical scope of the invention is not limited to the disclosed embodiments. On the contrary, the invention is intended to cover various modifications and equivalent arrangements included within the spirit and scope of the appended claims.

While the above embodiments have been described with reference to an application using a liquid-crystal light valve as display device, the invention is not limited to that, but may be applied to various spatial light modulators such as digital micromirror device (DMD).

While the above embodiments have been described with reference to an application using LEDs as light source, it should be understood that the invention is not limited to that, but may be applied to various light source such as high-pressure mercury lamps.

Additionally, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. A display device comprising:
a light modulation device having a plurality of pixels that display an image according to an image signal;
a light source that illuminates the light modulation device; and
a light-source driving device that controls an intensity of light by controlling a number of lightings per unit time, the light-source driving device controls the light source to light a fixed period at a specified brightness while the light source lights once.

2. The display device according to claim 1,
the light-source driving device including a brightness extraction device that extracts a parameter characterizing a brightness of an image from the image signal; and
the light-source driving device controlling the intensity of light on a basis of the parameter extracted by the brightness extraction device.

3. The display device according to claim 2, the display device being controlled so that the image signal displayed by the light modulation device is subjected to image processing on the basis of the parameter characterizing the brightness of the image.

4-6. (canceled)

7. The display device according to claim 1, the light-source driving device controlling the light source to be lit all the time when a parameter characterizing the brightness of the image is at a maximum.

8. The display device according to claim 1, the light-source driving device controlling the light source to be lit intermittently when a parameter characterizing the brightness of the image is at a maximum.

9. The display device according to claim 1, the light-source driving device controlling the lighting period in which the light source is lit at a specified brightness per unit time and controlling the light source to light at a brightness lower than the specified brightness during a time other than the lighting time.

10. A projection display device, comprising a projection device that projects the light modulated by the light modulation device, in addition to the display device according to claim 1.

11. The projection display device according to claim 10,
the projection display device including three light modulation elements corresponding to the three primary colors, and three light sources capable of emitting the respective color lights; and
the light-source driving device shifting lighting timing of the light-source for each of the different color lights.

12. The projection display device according to claim 10,
the projection display device including three light modulation elements corresponding to the three primary colors, and three light sources capable of emitting the respective color lights; and
the light-source driving device coinciding all lighting timing of the light-source with one another.

13. The projection display device according to claim 10, the light source including light-emitting diodes capable of emitting different color lights.
